(19) United States
(12) Patent Application Publication
(10) Pub. No.: US 2010/0319960 A1
(43) Pub. Date: Dec. 23, 2010

(54) HALOGEN-FREE FLAME RETARDANT FORMULATIONS

(75) Inventors: Stephen H. Cree, Hirzel (CH); Gerrit Groot-Enzerink, Schnetzerenbach (CH); Maria Ruiz, Horgen (CH)

Correspondence Address: The Dow Chemical Company, P.O. BOX 1967, 2040 Dow Center, Midland, MI, 48641, US

(73) Assignee: Dow Global Technologies Inc.

(21) Appl. No.: 12/866,584

(22) PCT Filed: Feb. 20, 2009
(86) PCT No.: PCT/US09/34668

§ 371 Date: Aug. 6, 2010

Related U.S. Application Data
(60) Provisional application No. 61/030,398, filed on Feb. 21, 2008.

(51) Int. Cl. H01B 7/295; C08K 3/22; C08K 3/10; C08L 51/00; C08L 53/00; C08K 5/14; C08L 37/00

(52) U.S. Cl. 174/110 SR; 524/570; 524/436; 524/437; 524/504; 524/505; 524/379; 524/549

(57) ABSTRACT

The present invention is a highly mineral-filled halogen-free, flame-retardant composition made from or containing a mineral filler, an olefin multi-block interpolymer, and a polar-monomer-based compatibilizer. The invented system has improved elongation at break, achieves a highly flexible, soft compound at high (e.g. >40 weight percent) filler addition, and achieves and low residual deformation when subjected to the hot pressure test. The invention also includes cables and extruded articles prepared from the composition.

The present invention relates to flame retardant formulations. The present invention relates in particular to halogen-free flame retardant (“HFFR”) formulations.

Cable manufacturers must evaluate a range of properties when selecting a product as an insulating or cable sheathing material. Properties include electrical performance, mechanical properties (e.g., tensile and flexural behavior), and overall system cost.

Another key parameter in the selection process is the fire safety of the cable, particularly the flame retardancy of the insulation/jacketing material. Flame retardancy can be achieved in a number of ways. One possibility is the addition of hydrated fillers, which dilute the concentration of flammable material and decompose below the degradation temperature of the polymer when exposed to heat, releasing water and removing heat from the fire source.

However, the use of hydrated mineral fillers in polyolefin wire and cable formulations suffers from a number of drawbacks, the majority of these stemming from the very high incorporation level of filler necessary to meet fire retardant specifications. To achieve any worthwhile level of fire performance, filler loadings of up to 60-65 weight percent in polyolefins are not uncommon. This level of filler has a drastic effect on polymer properties and leads to compounds with a high density and limited flexibility in addition to low mechanical properties, especially elongation at break.

Further many specifications call for a particular performance in the pressure test at high temperature or “hot pressure” or “hot knife” test. In the hot pressure test or hot knife test, a well-defined knife is placed on the sample under a specific weight at a specific temperature for specific time. Test temperature is generally 80 degrees Celsius, 90 degrees Celsius, or even higher, with the lower the permanent degree of penetration the better.

Some HFFR applications consider tear-strength as relevant to abuse resistance. Other applications consider it relevant to cracking resistance. In any event, tear strength is most often critical at operating temperature, rather than at room temperature.

Additionally, different fillers may have different effects on the properties of the composition or resulting article. For example, ground magnesium hydroxide can be more detrimental to tensile elongation than certain precipitated aluminum trihydrate.

Further, in order to enhance the mechanical properties of a polyolefin-hydrated mineral filled compound, some form of compatibilization is also needed between the basic polar filler surface and the inert polyolefin matrix. Filler suppliers have tackled this problem by supplying their fillers coated with carefully selected additives; however, an alternative procedure is to use small amounts of maleic anhydride grafted polymers or silane grafted polymers or in situ maleic anhydride or silane grafting.

Therefore, there is a need for an improved halogen-free flame retardant (“HFFR”) system with low hardness, high flexibility, high elongation at break values, low permanent deformation in the hot knife test at 80 degrees Celsius, 90 degrees Celsius, or higher, and suitable tear strength at operating conditions.

To that end, the presently invented highly mineral filled HFFR composition is provided, comprising a mineral filler, an olefin multi-block interpolymer, and a polar-monomer-based compatibilizer. Specifically, the present invention achieves high elongation at break, a highly flexible, soft compound at high (e.g. >40 weight percent) filler addition, and low residual deformation when subjected to the hot pressure test. The hot pressure test can be performed at 80 degrees Celsius or 90 degrees Celsius.

The composition of the present invention is useful in all applications where an improved flexibility flame retardant polyolefin composition having deformation resistance at 80 degrees Celsius, 90 degrees Celsius, or higher is required. Suitable examples include wire and cable accessories, insulation, jackets, sheaths, and over-sheaths. Furthermore, compositions of the present invention may be used as a highly flexible, non-crosslinked alternative in applications where the incumbent system is required to be crosslinked.

The hydrated, mineral filler should be present in >about 40 weight percent. Preferably, the mineral filler is present in the range of about 50-70 weight percent. Even more preferably, the mineral filler should be present in an amount of about 60-65 weight percent. Most preferably, the mineral filler should be magnesium hydroxide or aluminum trihydrate. The magnesium hydroxide can be ground or precipitated.

The olefin multi-block interpolymer should be present in the range of about 20-60 weight percent.

Olefin multi-block interpolymers may be made with two catalysts incorporating differing quantities of comonomer and a chain shuttling agent. Preferred olefin multi-block interpolymers are ethylene/α-olefin multi-block interpolymers. An ethylene/α-olefin multi-block interpolymer has one or more of the following characteristics:

(1) an average block index greater than zero and up to about 1.0 and a molecular weight distribution, Mw/Mn, greater than about 1.3; or

(2) at least one molecular fraction which elutes between 40 degrees Celsius and 130 degrees Celsius when fractionated using TREF, characterized in that the fraction has a block index of at least 0.5 and up to about 1; or

(3) an Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)²; or

(4) an Mw/Mn from about 1.7 to about 3.5, and is characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT>48 degrees Celsius for ΔH greater than 130J/g,

wherein the CRYSTAF peak is determined using at least 5 percent of the cumulative polymer, and if less than 5 percent of the polymer has an identifiable CRYSTAF peak, then the CRYSTAF temperature is 30 degrees Celsius; or

(5) an elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/a-olefin interpolymer is substantially free of a cross-linked phase: Re>1481−1629(d); or

(6) a molecular fraction which elutes between 40 degrees Celsius and 130 degrees Celsius when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/α-olefin interpolymer; or

(7) a storage modulus at 25 degrees Celsius, G′(25 degrees Celsius), and a storage modulus at 100 degrees Celsius, G′(100 degrees Celsius), wherein the ratio of G′(25 degrees Celsius) to G′(100 degrees Celsius) is in the range of about 1:1 to about 9:1.

In a further embodiment, the ethylene/α-olefin interpolymers are ethylene/α-olefin copolymers made in a continuous, solution polymerization reactor, and which possess a most probable distribution of block lengths. In one embodiment, the copolymers contain 4 or more blocks or segments including terminal blocks.

The ethylene/α-olefin multi-block interpolymers typically comprise ethylene and one or more copolymerizable α-olefin comonomers in polymerized form, characterized by multiple blocks or segments of two or more polymerized monomer units differing in chemical or physical properties. That is, the ethylene/a-olefin interpolymers are block interpolymers, preferably multi-block interpolymers or copolymers. In some embodiments, the multi-block copolymer can be represented by the following formula:

(AB)ₙ

where n is at least 1, preferably an integer greater than 1, such as 2, 3, 4, 5, 10, 15, 20, 30, 40, 50, 60, 70, 80, 90, 100, or higher, “A” represents a hard block or segment and “B” represents a soft block or segment. Preferably, the As and Bs are linked in a substantially linear fashion, as opposed to a substantially branched or substantially star-shaped fashion. In other embodiments, A blocks and B blocks are randomly distributed along the polymer chain. In other words, the block copolymers usually do not have a structure as follows.

AAA-AA-BBB-BB

In still other embodiments, the block copolymers do not usually have a third type of block, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The ethylene multi-block polymers typically comprise various amounts of “hard” and “soft” segments. “Hard” segments refer to blocks of polymerized units in which ethylene is present in an amount greater than about 95 weight percent, and preferably greater than about 98 weight percent based on the weight of the polymer. In other words, the comonomer content (content of monomers other than ethylene) in the hard segments is less than about 5 weight percent, and preferably less than about 2 weight percent based on the weight of the polymer. In some embodiments, the hard segments comprise all or substantially all ethylene. “Soft” segments, on the other hand, refer to blocks of polymerized units in which the comonomer content (content of monomers other than ethylene) is greater than about 5 weight percent, preferably greater than about 8 weight percent, greater than about 10 weight percent, or greater than about 15 weight percent based on the weight of the polymer. In some embodiments, the comonomer content in the soft segments can be greater than about 20 weight percent, greater than about 25 weight percent, greater than about 30 weight percent, greater than about 35 weight percent, greater than about 40 weight percent, greater than about 45 weight percent, greater than about 50 weight percent, or greater than about 60 weight percent.

The soft segments can often be present in a block interpolymer from about 1 weight percent to about 99 weight percent of the total weight of the block interpolymer, preferably from about 5 weight percent to about 95 weight percent, from about 10 weight percent to about 90 weight percent, from about 15 weight percent to about 85 weight percent, from about 20 weight percent to about 80 weight percent, from about 25 weight percent to about 75 weight percent, from about 30 weight percent to about 70 weight percent, from about 35 weight percent to about 65 weight percent, from about 40 weight percent to about 60 weight percent, or from about 45 weight percent to about 55 weight percent of the total weight of the block interpolymer. Conversely, the hard segments can be present in similar ranges. The soft segment weight percentage and the hard segment weight percentage can be calculated based on data obtained from DSC or NMR. Such methods and calculations are disclosed in U.S. patent application Ser. No. 11/376,835, incorporated by reference herein in its entirety.

The term “multi-block copolymer” or “segmented copolymer” refers to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In a preferred embodiment, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of both polydispersity index (PDI or Mw/Mn), block length distribution, and/or block number distribution due to the unique process making of the copolymers. More specifically, when produced in a continuous process, the polymers desirably possess PDI from 1.7 to 2.9, preferably from 1.8 to 2.5, more preferably from 1.8 to 2.2, and most preferably from 1.8 to 2.1. When produced in a batch or semi-batch process, the polymers possess PDI from 1.0 to 2.9, preferably from 1.3 to 2.5, more preferably from 1.4 to 2.0, and most preferably from 1.4 to 1.8.

In one embodiment, an ethylene/α-olefin multi-block interpolymer has an ethylene content of from 60 to 90 percent, a diene content of from 0 to 10 percent, and an α-olefin content of from 10 to 40 percent, based on the total weight of the polymer. In one embodiment, such polymers are high molecular weight polymers, having a weight average molecular weight (Mw) from 10,000 to about 2,500,000, preferably from 20,000 to 500,000, more preferably from 20,000 to 350,000; a polydispersity less than 3.5, more preferably less than 3 and as low as about 2; and a Mooney viscosity (ML (1+4) at 125 degrees Celsius) from 1 to 250.

In one embodiment, the ethylene multi-block interpolymers have a density of less than about 0.90 grams per cubic centimeter, preferably less than about 0.89 grams per cubic centimeter, more preferably less than about 0.885 grams per cubic centimeter, even more preferably less than about 0.88 grams per cubic centimeter and even more preferably less than about 0.875 grams per cubic centimeter. In one embodiment, the ethylene multi-block interpolymers have a density greater than about 0.85 grams per cubic centimeter, and more preferably greater than about 0.86 grams per cubic centimeter. Density is measured by the procedure of ASTM D-792. Low density ethylene multi-block copolymers are generally characterized as amorphous, flexible, and have good optical properties, for example, high transmission of visible and UV-light and low haze.

In one embodiment, the ethylene multi-block interpolymers have a melting point of less than about 125 degrees Celsius. The melting point is measured by the differential scanning calorimetry (DSC) method described in U.S. Publication 2006/0199930 (WO 2005/090427), incorporated herein by reference.

The ethylene multi-block interpolymers and their preparation and use, are more fully described in WO 2005/090427, US2006/0199931, US2006/0199930, US2006/0199914, US2006/0199912, US2006/0199911, US2006/0199910, US2006/0199908, US2006/0199907, US2006/0199906, US2006/0199905, US2006/0199897, US2006/0199896, US2006/0199887, US2006/0199884, US2006/0199872, US2006/0199744, US2006/0199030, US2006/0199006 and US2006/0199983; each publication is fully incorporated herein by reference.

The olefin multi-block interpolymer can be based on polypropylene whereby the crystalline segment of the chain is isotactic polypropylene. Also preferably, the elastomeric segment could be based on any alpha olefin copolymer system.

The compatibilizer polyolefin should be present in the range of about 2.5-10.0 weight percent. More preferably, it should be present in amount of about 5 weight percent.

Preferably, the polar-monomer-based compatibilizer is a maleic anhydride grafted olefin block interpolymer, maleic anhydride grafted polyolefin, a maleic anhydride coupling agent, or a silane compatibilizer. More preferably, the polar-monomer-based compatibilizer polyolefin is a maleic anhydride grafted polyolefin. When the polar-monomer-based compatibilizer is in a maleic anhydride-functionalized polyolefin, it can be prepared in situ through the addition of the maleic anhydride monomer, a peroxide, and the polyolefin. Suitable examples of maleic-anhydride grafted polyolefin elastomer compatibilizer include AMPLIFY™ GR functional polymers available from The Dow Chemical Company and FUSABOND™ modified polymers available from E. I. du Pont de Nemours and Company.

Suitable silane compatibilizers include silane-grafted polyolefins, vinyl silane compatibilizers, and alkoxy silane coupling agents.

The amount of polar monomer used can vary depending upon the nature of the polyolefin and the desired application.

As used herein, a compatibilizer is a component added to a blend of two or more immiscible polymers having poor mechanical properties because the interactions between the polymers are too low. An efficient compatibilizer has the same affinity for each of the polymers and permits the blends to form a stable blend, thereby improving the mechanical properties.

The composition may further comprise a polar copolymer such as EVA, EBA, or an acrylate. It is believed that the polar copolymer will facilitate improved drip performance and charring during flame testing.

The composition may further comprise other components, including other polymers, stabilizers (for example, for heat resistance, heat aging resistance in mediums such as air, water, and oil, metal deactivation, or ultraviolet resistance), dispersion aids, processing aids, nanoclays, inorganic fillers (such as calcium carbonate, talc, and silica), flame retardants, and flame retardant synergists. Flame retardant synergists like ultra high molecular weight polydimethylsiloxane are expected to improve flame retardancy. Other polymers include polyolefins such as high density polyethylene (“HDPE”), low density polyethylene (“LDPE”), linear low density polyethylene (“LLDPE”), and ultra low density polyethylene (“ULDPE”).

It is further contemplated within the scope of this invention that crosslinking of the polymers may be necessary to achieve heat deformation performance above the crystalline melting point of the polymer. Suitable methods of crosslinking the polymer include peroxide, silane, and e-beam.

In an alternate embodiment, the present invention comprises a mineral filler, an olefin multi-block interpolymers, an organic peroxide, and a polar graftable monomer.

In an alternate embodiment, the present invention comprises a mineral filler and a polar-monomer grafted olefin multi-block interpolymer. Preferably, the polar-monomer grafted olefin multi-block interpolymer is a maleic anhydride grafted olefin block interpolymer.

In yet another embodiment, the present invention is a cable comprising one or more electrical conductors or a core of one or more electrical conductors, each conductor or core being surrounded by a flame retardant layer comprising the halogen-free flame-retardant composition described herein.

In a further embodiment, the present invention is an extruded article comprising the halogen-free flame-retardant composition described herein.

### EXAMPLES

The following non-limiting examples illustrate the invention.

MAGNIFIN™ H5 magnesium hydroxide was obtained from Martinswerk GmbH. APYRAL™ 40CD aluminum hydroxide was obtained from Nabaltec GmbH. The fine-precipitated aluminum trihydrate was obtained from Nabaltec GmbH. The ground natural magnesium hydroxide was obtained form Nuova Sima srl.

The polypropylene homopolymer had a melt index of 25 grams per 10 minutes and was obtained from The Dow Chemical Company. For Comparative Example 1, the linear low density polyethylene had a melt index of 2.8 grams per 10 minutes, had a density of 0.918 grams per cubic centimeter, and was obtained from Exxon Mobil. For Comparative Examples 7, 10, and 12, and Example 13, the linear low density polyethylene had a melt index 0.9 gram per 10 minutes, had a density of 0.920 grams per cubic centimeter, and was obtained from The Dow Chemical company.

The ENGAGE™ 8100 ethylene octene polyolefin elastomer had a melt index of 1 gram per 10 minutes and a density of 0.870 grams per cubic centimeter, which was obtained from The Dow Chemical Company. The ENGAGE™ 7256 ethylene butene polyolefin elastomer had a melt index of 1 gram per 10 minutes and a density of 0.885 grams per cubic centimeter, which was obtained from The Dow Chemical Company. The ENGAGE™ 8540 ethylene octene polyolefin elastomer had a melt index of 1 gram per 10 minutes and a density of 0.908 grams per cubic centimeter, which was obtained from The Dow Chemical Company.

The FUSABOND™ 494D is a maleic anhydride grafted elastomer from DuPont, with a melt index of 1.3 grams pr 10 minutes and a density of 0.870 g/cm3. The FUSABOND™ 226D is a maleic anhydride grafted linear low density polyethylene available from DuPont, with a melt index of 1.5 grams per 10 minutes and a density of 0.930 g/cm3. For Comparative Examples 7, 9-12 and Examples 8 and 13, the maleic anhydride grafted elastomer had a melt index of 1.3 grams per 10 minutes, had a density of 0.87 grams per cubic centimeter, and was obtained from The Dow Chemical Company. For Examples 14 and 15, the maleic anhydride grafted elastomer had a melt index of 1.3 grams per 10 minutes, had a density of 0.87 grams per cubic centimeter, and was obtained from DuPont.

For Examples 6, 8, and 15, the ethylene/α-olefin block copolymer had a melt index of 1 gram per 10 minutes, had a density of 0.877 grams per cubic centimeter, and was obtained from The Dow Chemical Company. For Example 13, the ethylene/α-olefin block copolymer had a melt index of 1 gram per 10 minutes, had a density of 0.866 grams per cubic centimeter, and was obtained from The Dow Chemical Company. For Example 14, the ethylene/α-olefin block copolymer had a melt index of 5 grams per 10 minutes, had a density of 0.887 grams per cubic centimeter, and was obtained from The Dow Chemical Company.

For Comparative Example 7, the ethylene butyl acrylate (EBA) copolymer had a melt index 7 grams per 10 minutes, had a density of 0.924 grams per cubic centimeter, and was obtained from Lucobit. For Comparative Example 11 and 12, the ethylene butyl acrylate copolymer had a melt index 1.4 grams per 10 minutes, had a density of 0.924 grams per cubic centimeter, and was obtained from Lucobit. The ethylene vinyl acetate (EVA) copolymer had a melt index 6 grams per 10 minutes, had a density of 0.955 grams per cubic centimeter, and was obtained from DuPont.

### Testing for Samples in Table 1

### Measure:

(1) Shore D (ISO 868, 15 s)
(2) Tensile Test (ISO 527-1, 25 mm/mm speed, test specimen ISO 527-2 5 A)
(3) Flexural modulus (ISO 178, 1 mm/min speed, span distance=36 mm, 50×25×2 mm test specimen)
(4) Pressure test at high temperature [‘hot pressure’ or ‘hot knife’ test; 80×10×2 mm plaque, flat on flat supporting bar, loaded with 200 grams on a test device ('knife') as per DIN EN 60811-3 (−1), for 1 hour at 90 C, with a 2 hr cooling time.

### Testing for Samples in Tables 2 and 3

### Measure:

(1) Density (ISO 1183, method A)
(2) Shore D (ISO 868, 15 s)
(3) Tensile Test (ISO 527-1, 25 mm/mm speed, test specimen ISO 527-2 5 A)
(4) Flexural modulus (ISO 178, 1 mm/min speed, span distance=36 mm, 50×25×2 mm test specimen)
(5) Melt Flow Rate (ISO 1133—A, Ø 2.095×8 mm die, 21.6 kg)

(a) 190 degrees Celsius (magnesium hydroxide-based fillers)

(b) 160 degrees Celsius (aluminum hydroxide-based fillers)
(6) Pressure Test at High Temperature (DIN EN 60811-3-1, 8.2 adapted to pressed plaque simulating a 2 mm thick sheath, bent over Ø 21 mm bar, 6 h at temperature (80 to 125 degrees Celsius)), [‘hot pressure’ or ‘hot knife’ test].
(7) Limited Oxygen Index (ISO 4589-2 method A, test specimen type III)
(8) Vertical burning (UL 94 for V-0, V-1, V-2 classification, 2 mm thick test specimen)
(9) Cone calorimetry (ISO 5660, horizontal burning, 100×100×2 mm test specimen, 35 kW/m2 irradiation)
(10) Abrasion (ISO 4649 method B, 40 m of sliding distance)

### Comparative Examples 1-5 and Example 6

### Method A

### Addition of Polymeric Compatibilizer

Mixing procedure: On the Haake mixer, blend the components at 190 degrees Celsius and 50 to 75 rpm. Keep temperature below 210 C as the mineral filler will start to decompose. Add half the mineral filler then the polymeric compatibilizer. Mix at 190 degrees Celsius for 2-3 minutes. Then add the second portion of the mineral filler and finally the olefin block copolymer. Mix final compound at 75 rpm until the torque is level and a good blend is achieved. Keep temperature below about 200 C.

Compression mold plate: Conditions: 4 minutes preheat at 10 Bar and 160 degrees Celsius then 3 minutes at 100 Bar and 180 degrees Celsius. Cool using ISO program with fixed cooling rate.

### Method B

### In Situ Compatibilization

There is also the possibility to make the reactive compatibilization is situ. This is done by adding graftable polar monomers (such as maleic anhydride) and peroxide to the blend of hydrated filler and polyolefins during mixing under the influence of heat and for enough time to ensure complete peroxide decomposition.

Table 1 shows five comparative examples (Comparative Examples 1-5) and an example (Example 6) of the present invention. Comparative Examples 1-3 show the inability to balance desired properties of a high tensile elongation at break, with a low hardness and a good flexibility and hot deformation resistance, when highly filled. Comparative Examples 4 and 5 show the difficulty of a softer, flexible compound in resisting deformation in a hot pressure test. Both Comparative Examples 4 and 5 deform completely in the hot knife pressure test at 90 degrees Celsius (100% penetration) although they meet the hardness, flexibility and elongation targets.

Example 6 achieves extraordinarily high elongation at break of over 400%, shows <2% residual deformation when subjected to a hot pressure test at 90 degrees Celsius, and is a highly flexible, soft compound even at 65 weight percent filler addition.

TABLE 1

| Component | Comp. Ex. 1 | Comp. Ex. 2 | Comp. Ex. 3 | Comp. Ex. 4 | Comp. Ex. 5 | Example 6 |
|---|---|---|---|---|---|---|
| MAGNIFIN H5 | | 60 | | | | |
| APYRAL 40CD | 65 | | 65 | 65 | 65 | 65 |
| PP Homopolymer | | 35 | | | | |
| LLDPE (2.8 MI) | 30 | | | | | |
| ENGAGE 8100 | | | | | 30 | |
| ENGAGE 7256 | | | | 30 | | |
| ENGAGE 8540 | | | 30 | | | |
| Ethylene Block Copolymer | | | | | | 30 |
| FUSABOND 494D | | 5 | | 5 | | 5 |
| FUSABOND 226D | 5 | | 5 | | 5 | |

Properties

| | | | | | | |
|---|---|---|---|---|---|---|
| Shore D | 66 | 64 | 64 | 47 | 43 | 43 |
| Tensile Strength (MPa) | 19 | 21 | 18 | 10 | 12 | 8 |
| Elongation @ Break (%) | 30 | 15 | 180 | 240 | 225 | 420 |
| Hot Knife (% penetration) | 0 | 0 | 0 | 100 | 100 | 2 |
| Flexural Modulus (MPa) | 950 | 740 | 860 | 90 | 80 | 80 |

### Comparative Example 7 and Example 8

Mixing procedure: In a W&P 1 L 2 rotors internal mixer, components were blended at temperatures ranging from 117 to 135 C and mixing times were between 18 and 40 minutes. Mixing batches were made uniform afterwards in a Collin roll mill for 5 to 8 minutes with 145-160 C at the rolls.

Compression mold conditions: 2 mm thick plaques shaped in a Burkle press, 5-minute preload time at 5 to 10 bar plus 3 minutes at 200 bar, preload and load at 180 C for magnesium hydroxide-based fillers or 160 C for aluminum hydroxide-based fillers. Gradient cooling set at 15±5 C/min (ISO 293 method B).

Comparative Example 7 shows that a typical HFFR formulation based on an EBA and LLDPE blend as the polymer carrier system with APYRAL 40CD can result in fair compound properties. A significant increase of the filler level can reduce the properties to unacceptable levels. Notably, Example 8 shows that the present invention allows an increase of aluminum trihydrate to as high as 75 weight percent while achieving physical properties that are better (higher tensile strength, higher tensile elongation at break, lower flexural modulus) than for the comparative example at a mineral filler level of only 60 weight percent. Also the Limiting Oxygen Index, an indication for flame retardancy, is significantly better.

TABLE 2

| Component | Comparative Ex. 7 | Example 8 |
|---|---|---|
| LLDPE (0.9 MI) | 13 | |
| EBA | 22 | |
| Ethylene Block Copolymer | | 20 |
| FUSABOND 494D | 5 | 5 |
| APYRAL 40CD | 60 | 75 |

Properties

| | | |
|---|---|---|
| Density | 1.46 | 1.69 |
| Shore D | 53 | 5.1 |
| Tensile Stress - Maximum (MPa) | 11.7 | 12.0 |
| Tensile Stress at Break (MPa) | 10.7 | 12.0 |
| Elongation at Break (%) | 110 | 135 |
| Flexural Modulus (MPa) | 263 | 172 |
| Limiting Oxygen Index | 26 | 48 |
| Melt Flow Rate (g/10 min) | 22 | 1 |

### Comparative Example 9-12 and Examples 13-16

Comparative Examples 9-12 were prepared according to the mixing and compression mold conditions described for Comparative Example 7 and Example 8. Comparative Examples 9-12 show poor elongations at break value when the hydrated filler used is a ground magnesium hydroxide. All four compounds have elongations at break well below 100%, with Comparative Examples 10-12 showing even less than 50% elongations at break.

On the other hand, Example 13, based on a blend of an olefin block copolymer and a linear low density polyethylene, shows a very good balance of properties, with a high tensile elongation, and a good tensile strength and a relatively low flexural modulus. The performance in the hot pressure test exceeds that of 90 degrees Celsius and can even meet <50% indentation at 110 degrees Celsius (6 hr acc. Standard). It is anticipated that blends of properly selected EVA or EBA or other co-polymers with olefin block copolymer materials will achieve improved flame retardancy.

Example 14 shows a very good tensile elongation and a very low flexural modulus while achieving fair tensile strength. Example 15 demonstrates the impact of the selection of olefin block copolymer on final compound property balance. Example 16 shows a good property balance at even higher levels of ground magnesium hydroxide.

TABLE 3

| Components | Comp. Ex. 9 | C. Ex. 10 | C. Ex. 11 | C. Ex. 12 | Example 13 | Example 14 | Example 15 | Example 16 |
|---|---|---|---|---|---|---|---|---|
| LLDPE | | 13 | | 13 | 15 | | | |
| EVA | 34.5 | 21.5 | | | | | | |
| EBA | | | 34.5 | 21.5 | | | | |
| Ethylene Block Copolymer 1 | | | | | 20 | | | 30 |
| Ethylene Block Copolymer 2 | | | | | | | 35 | |
| Ethylene Block Copolymer 3 | | | | | | 35 | | |
| MAH-grafted Elastomer 1 | | | | | | 5 | 5 | |
| MAH-grafted Elastomer 2 | 5 | 5 | 5 | 5 | 5 | | | 5 |
| Ground natural magnesium hydroxide | 60 | 60 | 60 | 60 | 60 | 60 | 60 | 65 |
| Stearic Acid | 0.5 | 0.5 | 0.5 | 0.5 | | | | |

Properties

| | | | | | | | | |
|---|---|---|---|---|---|---|---|---|
| Density | 1.48 | 1.46 | 1.45 | 1.46 | 1.42 | 1.42 | 1.42 | 1.48 |
| Shore D | 45 | 52 | 50 | 55 | 47 | 43 | 36 | 36 |
| Tensile Stress at Break (MPa) | 9.2 | 11.7 | 11.1 | 13.5 | 13.6 | 10.4 | 9.5 | 11.0 |
| Tensile Stress - Maximum (MPa) | 10.3 | 12.8 | 12.1 | 14.5 | 14.0 | 11 | 9.9 | 11.1 |
| Tensile Elongation at Break (%) | 72 | 40 | 41 | 32 | 137 | 175 | 280 | 164 |
| Flexural Modulus (MPa) | 114 | 248 | 224 | 329 | 213 | 164 | 93 | 85 |
| Pressure Test | | | | | ~11 | ~115 | ~110 | |
| Limiting Oxygen Index | 35 | 32 | 31 | 34 | 30 | 28 | 29 | 33 |
| MFR | 23 | 9 | 15 | 11 | 7 | 23 | 4 | 3 |
| UL94 Rating | | | | | | NR | V-1 | |
| Cone | | | | | | Y | Y | |
| Abrasion Volume Loss (mm³) | | | | | | 123 | 119 | |
| Abrasion Mass Loss (mg) | | | | | | 180 | 173 | |

### Tear Strength

### Comparative Examples 17-19 and Examples 20-21

Tear-strength for HFFR jackets typically reduces with temperature. Tear strength measurements were performed on samples from commercial mineral filled HFFR compounds according to ISO 34, at 100 m/min on sets of test samples.

Comparative Example 17 was MEGOLON™ S642 thermoplastic, halogen free, fire retardant sheathing compound available from AlphaGary Corporation. Comparative Example 18 was COGEGUM™ AFR/920 thermoplastic halogen-free fire retardant compound, for sheathing and insulation of power, signal and control cables available from Solvay Padanaplast. Comparative Example 19 was COGEGUM™ AFR/930 thermoplastic halogen-free fire retardant flexible compound, for sheathing and insulation of power, signal and control cables also available from Solvay Padanaplast.

The commercial mineral filled HFFR compounds were obtained from IRGANOX™ 1010 phenolic antioxidant and IRGAFOS™ P168 phosphite antioxidant are available from Ciba Corporation. PMDSO is an ultra high molecular weight polydimethylsiloxane in a linear low density polyethylene 50:50 masterbatch.

Five test bars were prepared per sample by cutting them from compression molded plaques. Compression molding conditions were as described for Comparative Example 7 and Example 8.

The sample sets were conditioned at either room temperature, 45 degrees Celsius or 70° degrees Celsius. —Tear Strength is reported in N/mm.

The test results confirm a reduction of tear strength with temperature increase. Some of these samples show very high tear-strength values at room temperature, but also a rapid decline of this value with temperature increase, resulting in low values for tear-strength at 70 degrees Celsius.

Experimental samples based on olefin multi-block interpolymers show improved tear-resistance behavior. At room temperature the tear-strength measured for this very flexible sample is not extraordinarily high. However with increase in temperature, the measured value for tear-strength increases and achieves relatively and absolutely high values at 45 degrees Celsius. With further temperature increase, the tear strength then decreases to a lower, but still relatively high value at 70 degrees Celsius.

For Example 21, there was no peak in measured shear-strength value at 45 degrees Celsius, but the decline in shear strength value with temperature is relatively low, and the final value at 70 degrees Celsius was more than three times that of the best commercial reference, Comparative Example 18.

TABLE 4

| Component | Comp. Ex. 17 | Comp. Ex. 18 | Comp. Ex. 19 | Example 20 | Example 21 |
|---|---|---|---|---|---|
| OBC-1 | | | | 30 | |
| OBC-2 | | | | | 27.6 |
| MAH-grafted elastomer | | | | 5 | 5 |
| Magnesium hydroxide | | | | 65 | 65 |
| PMDSO | | | | | 2 |
| Irganox 1010 | | | | | 0.2 |
| Irgafos P168 | | | | | 0.2 |

Properties

| | | | | | |
|---|---|---|---|---|---|
| Tear Strength, RT | 12.4 | 14.7 | 13.0 | 10.0 | 10.5 |
| Tear Strength, 45 degrees Celsius | 9.9 | 9.7 | 5.2 | 17.5 | 8.5 |
| Tear Strength, 70 degrees Celsius | 0.2 | 1.6 | 0.7 | 2.1 | 5.7 |

What is claimed is:

1. A halogen-free, flame-retardant composition comprising:
(a) a mineral filler;
(b) an olefin multi-block interpolymer; and
(c) a polar monomer-based compatibilizer.

2. The halogen-free, flame-retardant composition of claim 1 wherein the mineral filler is present in an amount greater than 40 weight percent.

3. The halogen-free, flame retardant composition of claim 2 wherein the mineral filler is selected from the group consisting of magnesium hydroxide and aluminum trihydrate.

4. The halogen-free, flame-retardant composition of any of claims 1 to 3 wherein the olefin multi-block interpolymer is present in an amount between about 20 weight percent and 60 weight percent.

5. The halogen-free, flame retardant composition of claim 4 wherein the olefin multi-block interpolymer is an ethylene/α-olefin multi-block interpolymers.

6. The halogen-free, flame-retardant composition of claim 1 or claim 2 wherein the polar monomer-based compatibilizer is selected from the group consisting of a maleic anhydride grafted olefin block interpolymer, a maleic anhydride grafted polyolefin, a maleic anhydride coupling agent, and a silane compatibilizer.

7. The halogen-free, flame retardant composition of claim 6 wherein the polar monomer-based compatibilizer is a maleic anhydride grafted polyolefin.

8. A halogen-free, flame-retardant composition comprising:
(a) a mineral filler;
(b) an olefin multi-block interpolymer;
(c) an organic peroxide; and
(d) a polar graftable monomer.

9. A halogen-free, flame-retardant composition comprising:
(a) a mineral filler; and
(b) a polar-monomer grafted olefin multi-block interpolymer.

10. The halogen-free, flame retardant composition of claim 9 wherein the polar monomer grafted olefin multi-block interpolymer is a maleic anhydride grafted olefin block interpolymer.

11. A cable comprising one or more electrical conductors or a core of one or more electrical conductors, each conductor or core being surrounded by a halogen-free, flame retardant layer comprising the halogen-free, flame-retardant composition according to any of claims 1 to 10.

12. An extruded article comprising the halogen-free, flame-retardant composition according to any of claims 1 to 10.
